(19) United States
(12) Patent Application Publication
(10) Pub. No.: US 2026/0097595 A1
(43) Pub. Date: Apr. 9, 2026

(54) PRINTING APPARATUS, PRINTING METHOD, AND NON-TRANSITORY COMPUTER READABLE STORAGE MEDIUM

(71) Applicant: CANON KABUSHIKI KAISHA, Tokyo (JP)

(72) Inventors: KAZUKI NARUMI, Tokyo (JP); YUTARO NAKATSUKA, Kanagawa (JP); TORU OHNISHI, Kanagawa (JP); YOICHI TAKADA, Kanagawa (JP); AKIRA YAMAMOTO, Kanagawa (JP); TATSUAKI ORIHARA, Tokyo (JP); KENJI SHINJO, Kanagawa (JP)

(21) Appl. No.: 19/353,136

(22) Filed: Oct. 8, 2025

(30) Foreign Application Priority Data
Oct. 9, 2024 (JP) 2024-177386

(51) Int. Cl. B41J 11/46; B41J 11/00; B41J 29/377

(52) U.S. Cl. CPC B41J 11/46; B41J 11/0022; B41J 11/008; B41J 11/0095; B41J 29/377

(57) ABSTRACT

A printing apparatus which performs drying between a first printing unit and a second printing unit calculates a first amount of registration misalignment between the printing units based on a pattern printed in a first area for detecting a registration misalignment between the printing units and amounts of registration misalignment within print heads of the printing units. Based on the calculated first amount of registration misalignment and a pattern printed in a second area for detecting a registration misalignment between the printing units, the printing apparatus calculates a second amount of registration misalignment between the printing units resulting from expansion or contraction of the sheet in its conveyance direction due to heating and cooling. The printing apparatus performs a scaling process on image data for the first printing unit or adjusts the ejection frequency of the print head of the first printing unit according to the calculated second amount of registration misalignment.

### BACKGROUND

### Field of the Technology

The present disclosure relates to a technique for controlling a printing apparatus that dries a print medium after printing.

### Description of the Related Art

In recent years, for printing apparatuses that perform inkjet printing on print media, there has been a demand for high-quality printing of white and colors. Thus, there are printing apparatuses including separate printing units for white and colors and provided with a drying unit between them. By providing a drying unit between a white printing unit and a color printing unit as with such a printing apparatus, it is possible to print images without getting the white ink and the color inks mixed. Japanese Patent Laid-Open No. 2019-005716 discloses a printing apparatus which, in a method of performing printing on a film in white and colors, performs color printing with an inkjet printer and white printing by applying a white ink with a gravure roll, and executes a drying process at a position downstream of each printing process. Also, the printing apparatus disclosed in Japanese Patent Laid-Open No. 2019-005716 cools the film after heating it to suppress deformations of the film, such as expansion, contraction, and waviness.

### SUMMARY

The present disclosure provides a printing apparatus having: a first printing unit which prints a first image on a print medium; a second printing unit which prints a second image on the print medium on which the first image has been printed by the first printing unit; a control unit which controls a printing position of the first printing unit or a printing position of the second printing unit; a detection unit which detects a detection mark printed by the first printing unit in order to determine printing timing for the second printing unit; and an obtaining unit which obtains a first misalignment amount and a second misalignment amount, the first misalignment amount corresponding to a misalignment in the printing position of the first printing unit on the print medium in a width direction of the print medium, the second misalignment amount corresponding to a misalignment in the printing position of the second printing unit on the print medium in the width direction. In a case of printing a maintenance pattern for registration adjustment on the print medium as the first image and the second image, the control unit performs controls based on the first misalignment amount and the second misalignment amount obtained by the obtaining unit such that a printing position of the detection mark to be printed by the first printing unit will be within a detection range of the detection unit.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram illustrating an internal configuration of a printing apparatus.

FIG. 2 is a perspective view of a sheet conveyance unit housing of a printing unit according to one embodiment.

FIG. 3 is a perspective view of a print head raising-lowering mechanism according to one embodiment.

FIG. 4 is a block diagram of a control unit of a printing apparatus according to one embodiment.

FIG. 5 is a flowchart illustrating processing from printing a maintenance pattern to reading the printed maintenance pattern according to Embodiment 1.

FIG. 6A is a diagram illustrating a maintenance pattern A printed by one of two printing units according to Embodiment 1.

FIG. 6B is a diagram illustrating a maintenance pattern B printed by one of the two printing units according to Embodiment 1.

FIG. 7 is a diagram illustrating a maintenance pattern obtained by overlaying the maintenance patterns A and B and a description of the pattern in each area according to Embodiment 1.

FIG. 8 is a flowchart illustrating processing for calculating the amounts of registration misalignments from the maintenance pattern read according to Embodiment 1.

FIG. 9 is a diagram illustrating an example configuration of a print head according to one embodiment.

FIG. 10 is a flowchart illustrating processing of automatic registration adjustment according to Embodiment 2.

FIG. 11A is a diagram for describing a method of adjusting the positions of sheet edges by a meandering correction unit according to one embodiment.

FIG. 11B is a diagram for describing the method of adjusting the positions of the sheet edges by the meandering correction unit according to the one embodiment.

FIG. 12 is a diagram illustrating an example of a width-direction registration adjustment pattern according to Embodiment 2.

FIG. 13A is a diagram illustrating an example where a width-direction registration adjustment value is applied to the printing position of a detection mark and a maintenance pattern.

FIG. 13B is a diagram illustrating the example where the width-direction registration adjustment value is applied to the printing position of the detection mark and the maintenance pattern.

FIG. 14 is a diagram illustrating an example configuration of a print head according to one embodiment.

FIG. 15 is a diagram illustrating a maintenance pattern for calculating inter-array registration adjustment values according to Embodiment 3.

### DESCRIPTION OF THE EMBODIMENTS

The technique described in Japanese Patent Laid-Open No. 2019-005716 can suppress major deformation of the print medium through temperature management, but cannot suppress subtle expansion or contraction of the print medium caused by residual stress or the like from the manufacturing process, which varies from one print medium to another. Thus, there remains a problem that color shifts occur due to the expansion or contraction of the print medium.

In view of this, the present disclosure is aimed at reducing color shifts by a printing apparatus that performs multiple separate printing processes.

Embodiments of the present disclosure will now be specifically described below with reference to the drawings. It is to be noted that the components described in the following embodiments are mere examples, and the apparatus configuration and various conditions to which the present disclosure is applied can be modified or changed as appropriate without departing from the gist of the present disclosure, and are not limited to the following embodiments. For example, the dimensions, materials, and shapes of constituent parts described in the following embodiments as well as their relative positions and so on can be changed as appropriate based on the apparatus configuration and various conditions to which the present disclosure is applied, and the present disclosure is not limited to the following embodiments unless otherwise noted.

### Embodiment 1

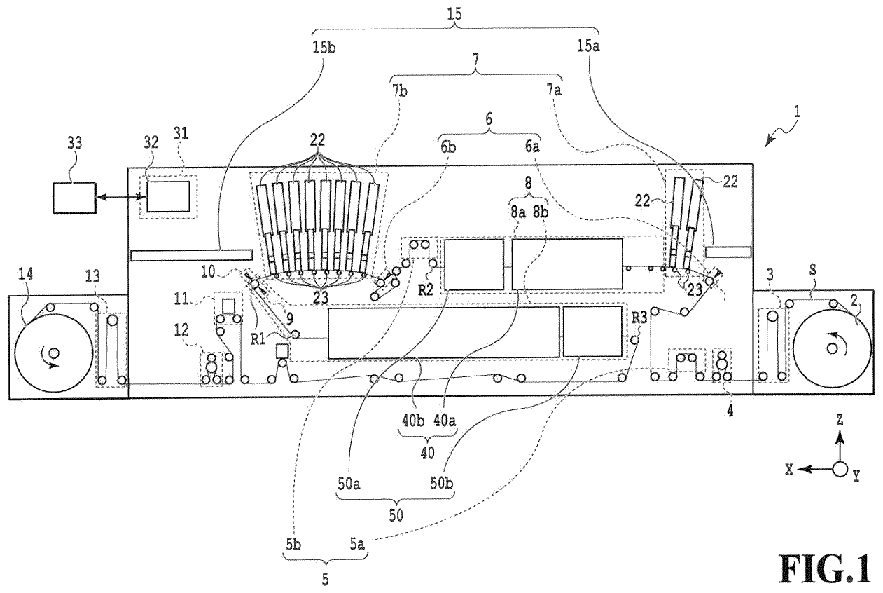

First of all, the upper side of the apparatus in FIG. 1 is defined as the top side, the direction from right to left is defined as the longitudinal direction, and the direction from the front to the back of the sheet of FIG. 1 perpendicular to the print medium conveyance direction is defined as the sheet width direction. A printing apparatus 1 is a high-speed line printer that uses a continuous sheet rolled in a roll form as a print medium.

### Printing Apparatus

FIG. 1 illustrates a schematic cross-sectional view of the printing apparatus 1 according to the present embodiment. The printing apparatus 1 in the present embodiment includes a conveyance mechanism including an unwinding unit 2, a first dancer unit 3, a first main conveyance unit 4, a meandering correction unit 5, a conveyance detection unit 6, a conveyance tension detection unit 9, a second main conveyance unit 12, a second dancer unit 13, and a winding unit 14. Also, the printing apparatus 1 includes a printing mechanism including a printing unit 7, a printed image position detection unit 10, a scanner unit 11, a maintenance unit 15, a drying unit 40, and a cooling unit 50. A continuous sheet S, which is a print medium, is conveyed along the sheet conveyance path illustrated by a solid line in the figure and is processed by each unit. Incidentally, in the present embodiment, the drying unit 40 and the cooling unit 50 are distinguished but the drying unit 40 and the cooling unit 50 may be combined into a drying unit.

The printing apparatus 1 has a configuration for performing a first printing process and a second printing process along the sheet conveyance path. In the first printing process, the sheet S is passed through a first printing unit 7a, a first drying unit 40a, and a first cooling unit 50a to fix and print an image on the sheet S. In the second printing process, the sheet S subjected to the first printing process is passed through a second printing unit 7b, a second drying unit 40b, and a second cooling unit 50b to fix and print an image on the sheet S. As described above, the printing apparatus 1 is capable of continuously printing images on the sheet S without getting the colors mixed by performing the above first printing process and second printing process on the sheet S. Also, the printing apparatus 1 is capable of selecting one of the printing processes depending on the printing conditions, and performs only the selected printing process to print an image on the sheet S. Note that, regarding the conveyance of the sheet S, conveyance in the direction from the unwinding unit 2 to the winding unit 14 is defined as forward (+x) conveyance, and the opposite is defined as reverse (−x) conveyance. Also, the direction toward the right with respect to the conveyance direction along the width direction crossing the conveyance direction (print head nozzle array direction) is defined as “+y direction,” and the direction which is perpendicular to the conveyance surface of the conveyance path and in which the print medium faces is defined as “+z direction.”

The unwinding unit 2 is a unit for holding and feeding a roll sheet which is a continuous sheet rolled in the form of a roll. The unwinding unit 2 is configured to accommodate a roll sheet and unwind the roll sheet to feed a sheet S. Note that the number of roll sheets that can be accommodated is not limited to one, and the unwinding unit 2 may be configured to accommodate a plurality of roll sheets and unwind a selected one of the roll sheets to feed sheet S. Note that the rotation of the unwinding unit 2 is controlled to be capable of rotating forward and backward with a motor (not illustrated).

The first dancer unit 3 is a unit for applying a constant sheet tension between the unwinding unit 2 and the first main conveyance unit 4 with a tension application unit not illustrated.

The first main conveyance unit 4 is a unit for feeding the sheet S to each unit provided along the sheet conveyance path while applying a sheet tension in cooperation with the second main conveyance unit 12, and is driven by a motor not illustrated to convey the sheet S under tension.

The meandering correction unit 5 is a unit for correcting meandering of the sheet S in the sheet width direction during its conveyance under tension. In the present embodiment, the meandering correction unit 5 is a first meandering correction unit 5a and a second meandering correction unit 5b provided upstream of the respective printing processes on the sheet conveyance path. The meandering correction unit 5 includes meandering correction rollers and meandering detection sensors not illustrated that detect meandering of the sheet S. The meandering correction rollers are capable of changing the tilt of the sheet S with motors not illustrated, and corrects meandering of the sheet S based on the results of measurements by the meandering detection sensors. The meandering correction unit 5 wraps the sheet S over the meandering correction rollers to enhance the meandering correction function.

The conveyance detection unit 6 is a unit for detecting a predetermined detection mark printed on the sheet S in advance in order to control the image printing timing for the printing unit 7. In the present embodiment, the conveyance detection unit 6 is a first conveyance detection unit 6a and a second conveyance detection unit 6b provided upstream of the respective printing processes on the sheet conveyance path. The first conveyance detection unit 6a and the second conveyance detection unit 6b are used to control the image printing timings for the first printing unit 7a and the second printing unit 7b, respectively.

The printing unit 7 applies liquid compositions (inks) to the sheet S conveyed thereto with print heads 22 from above the sheet S to form images. The sheet conveyance path at the printing unit 7 is formed by guide rollers 23 disposed in an arc shape bulging upward. There, a constant tension is applied to the sheet S to leave a constant clearance between the sheet Sand the print heads 22. Multiple print heads 22 are installed at the printing unit 7 along the conveyance direction. In the present embodiment; the first printing unit 7a has a total of two line-type print heads for a white (W) ink and a reaction liquid. The second printing unit 7b a total of eight line-type print heads for four colors of black (Bk), yellow (Y), magenta (M), and cyan (C) and additionally for a reaction liquid and three spot colors. Each reaction liquid is a liquid containing a component that increases the viscosity of the ink or inks. Here, increasing the viscosity of an ink means to bring the color material, the resin, and so on forming the ink into contact with a component that increases the viscosity of the ink to thereby induce a chemical reaction or physical adsorption leading to a state where the viscosity of the ink is raised. Increasing the viscosity of an ink is not limited to raising the viscosity of the entire ink but also includes locally raising the viscosity as a result of partial aggregation of the ink's constituent component, such as its color material or resin. The component that increases the viscosity of the ink may be a metallic ion, a polymeric aggregation agent, or the like. While the component is not particularly limited, it is possible to use a substance that induces a change in the pH of the ink to aggregate the color material in the ink, and an organic acid is usable. Applying the reaction liquid onto the sheet S before the application of the ink or inks enables the ink or inks to be fixed to the sheet S as soon as the ink or inks land on the sheet S. This prevents bleeding in which adjacent inks get mixed.

Note that the types and number of colors and the number of print heads 22 are not limited to the types and numbers in the present embodiment. As for the inkjet method, it is possible to employ a method using heating elements, a method using piezoelectric elements, a method using electrostatic elements, a method using micro electromechanical systems (MEMS) elements, or the like. The inks are supplied to the respective print heads 22 through respective ink tubes from respective ink tanks not illustrated.

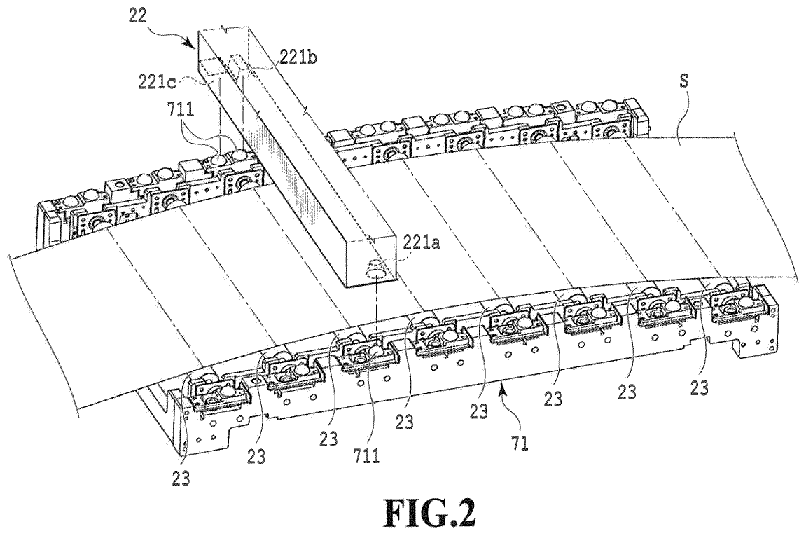

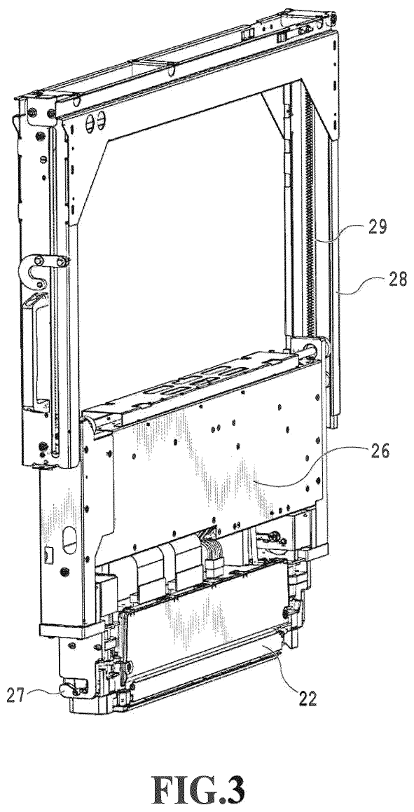

As illustrated in FIG. 2, multiple print head positioning members 711 for positioning the print heads 22 are installed on a sheet conveyance unit housing 71 of the printing unit 7. In the present embodiment, the print head positioning members 711 are installed on both sides the sheet S, one on the near side in the sheet width direction and two on the far side per print head 22. Also, as illustrated in FIG. 3, each print head 22 is pivotally supported such that a print head support shaft 27 is supported from below by a print head holding unit 26 which holds and vertically raises and lowers the print head 22. The print head holding unit 26 performs an operation of moving up and down along raising-lowering rails 29 included in a print head raising-lowering frame 28 with a driving mechanism not illustrated incorporated in the print head holding unit 26. Incidentally, in this example, inkjet heads are used to apply the inks onto the sheet S, but the method of applying the inks onto the sheet at the printing unit 7 is not particularly limited to this method. For example, while the reaction liquids are applied by print heads 22 in this example, a configuration that applies the reaction liquids with rollers, die coating apparatuses (die coaters), blade coating apparatuses (blade coaters), or the like may be employed.

The conveyance tension detection unit 9 is a unit for detecting the tension in the conveyance of the sheet S under tension between the first main conveyance unit 4 and the second main conveyance unit 12.

The printed image position detection unit 10 is a unit that, during printing, detects a misalignment of an image formed on the sheet S by the printing unit 7 to correct the printing.

Wrapping guide rollers R1 are rollers over each of which the opposite surface of the sheet S from its ink application surface at a position downstream of the second printing unit 7b in the conveyance direction is wrapped at a certain wrapping angle. In the present embodiment, two wrapping guide rollers R1 are disposed between the second printing unit 7b and the second drying unit 40b, and the sheet S is bent over such that the portion on the upper side of the apparatus and the portion on the lower side of the apparatus are substantially parallel to each other. The second drying unit 40b is disposed on the lower side of the apparatus relative to the second printing unit 7b.

The drying unit 40 (first drying unit 40a and second drying unit 40b) is a unit for reducing the liquid components contained in the liquid compositions applied onto the sheet S by the printing unit 7 to enhance the fixability of the inks to the sheet S. The drying unit 40 applies air at a predetermined temperature onto the printed sheet S to dry the applied inks. Inside the drying unit 40, warm air is applied to the sheet S passing therethrough at least from the side facing the ink application surface of the sheet S to dry the ink application surface. Incidentally, the drying method may combine the method which applies warm air with a method which irradiates the surface of the sheet S with electromagnetic waves (such as ultraviolet rays or infrared rays) and/or a conduction heat transfer method which uses contact with a heating body.

The cooling unit 50 (first cooling unit 50a and second cooling unit 50b) cools the sheet S heated by the drying unit 40 to solidify the soft inks, and also controls the temperature of the sheet S at an appropriate temperature for the process on the downstream side in the printing apparatus. Inside the cooling unit 50, air cooler than the sheet S passing therethrough is applied to the sheet S at least from the side facing the ink application surface of the sheet S to cool the ink application surface. Note that the cooling method is not limited to the method which applies air, and may be a conduction heat transfer method which uses contact with a heat dissipation member or a combination of these methods.

The scanner unit 11 is a unit that reads a test image or a maintenance pattern formed on the sheet S by the printing unit 7 before actual printing. The images read by the scanner unit 11 will be used by a control unit 31 to be described next to detect a positional misalignment of the image printed by the printing unit 7 and the density of the inks.

As means for adjusting this positional misalignment of the image, the registration adjustment to be described later is usually performed. This serves as important control for implementing high-definition image printing. Hereinafter, the printing position will be referred to as “registration,” and a misalignment in printing position will be referred to as “registration misalignment.”

The second main conveyance unit 12 is a unit that conveys the sheet S while applying a tension to the sheet S in cooperation with the first main conveyance unit 4 to adjust the tension on the sheet S. The second main conveyance unit 12 is driven by a motor not illustrated and, with a tension control unit not illustrated, controls the conveyance speed according to the value of the tension detected by the conveyance tension detection unit 9. Incidentally, as an additional configuration to adjust the tension on the sheet S, a configuration that adjusts the tension on the sheet S with a clutch (not illustrated) capable of controlling a drivingly coupled torque may be added. As for the tension control method in this case, a torque control method which controls the value of the torque transmitted from the clutch, and a speed control method which controls the roller speed of the second main conveyance unit 12 can be employed, and the tension control method can be switched between these two methods or both can be simultaneously used according to the purpose.

The second dancer unit 13 is a unit for applying a constant sheet tension between the second main conveyance unit 12 and the winding unit 14. The second dancer unit 13 applies the sheet tension with a tension application unit not illustrated.

The winding unit 14 is a unit for winding up the sheet S after the printing process around a roll core. The number of rolls that can be collected is not limited to one. The configuration may be such that two roll cores or three or more roll cores are provided, and the roll core to be used is alternatively switched to collect the sheet S into multiple rolls. The rotation of the winding unit 14 is controlled by a driving motor (not illustrated) alone such that the winding unit 14 can be rotated forward and backward. The driving motors for the unwinding unit 2 and the winding unit 14 (not illustrated) are controlled to rotate in the forward or backward direction to convey the sheet S in the forward or backward direction. In the backward conveyance too, the sheet S is conveyed under tension between the first main conveyance unit 4 and the second main conveyance unit 12 as in the forward conveyance. Incidentally, depending on the content of the post-printing process of the sheet S, a configuration to cut the sheet S with a cutter and stack the cut sheets S may be employed instead of the configuration to wind up the sheet S around a roll core.

### Print Heads

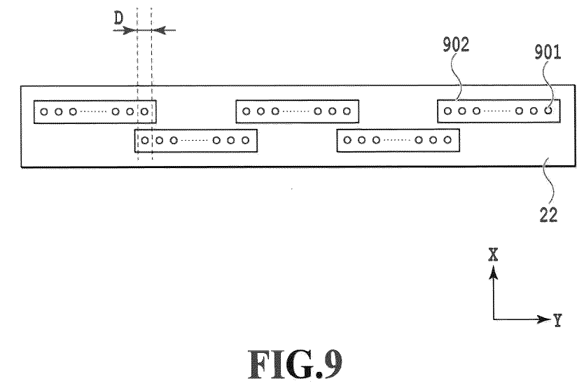

FIG. 9 is a schematic configuration diagram of a print head 22 used in the printing apparatus 1 according to the present embodiment. In each print head 22, multiple printing element substrates 902 are continuously disposed in the y direction with an overlap area D provided by shifting their positions in the x direction. Each printing element substrate 902 includes multiple nozzles 901 arrayed at a constant pitch. By causing each individual nozzle 901 to eject an ink at a constant frequency in accordance with print data onto a print medium conveyed at a constant speed in the x direction, an image is formed on the print medium at a resolution corresponding to the pitch at which the nozzles 901 are arrayed. In the present embodiment, the array pitch is 1200 dpi. The pixel size at 1200 dpi is approximately 20 μm, and registration adjustment requires accuracy in units of 20 μm. Here, “print data” is data specifying the contents of various processes to be performed by the printing apparatus 1 including image data to be used in image forming.

The control unit 31 is a unit that controls units in the whole printing apparatus. The control unit 31 also has a controller including various control units, an external interface, and an operation unit 32 on which the user performs input-output operations.

Operation of the printing apparatus 1 is controlled in accordance with instructions from a controller or a host apparatus 33, such as a host computer, connected to the controller through an external interface. The control unit 31 includes an image processing unit 401, a central processing unit (CPU) 404, a random-access unit (RAM) 405, a read-only memory (ROM) 406, a print control unit 402, and an image reading computation unit 403. The CPU 404 executes processes according to each embodiment to be described later in accordance with programs and various pieces of data held in the RAM 405 or the ROM 406. The RAM 405 is a volatile storage and temporarily holds programs and data. The ROM 406 is a non-volatile storage and holds various pieces of data, such as table data and programs to be used in the processes to be described later.

Note that the present embodiment will be described below on the assumption that the host apparatus 33 is a personal computer (PC) separate from the printing apparatus 1, but how they are implemented is not particularly limited as long as similar processes can be performed. For example, the host apparatus 33 may be an apparatus incorporated in the printing apparatus 1 or a server. In another example, the host apparatus 33 may be a mobile terminal, such as a smartphone, a tablet terminal, or an imaging apparatus.

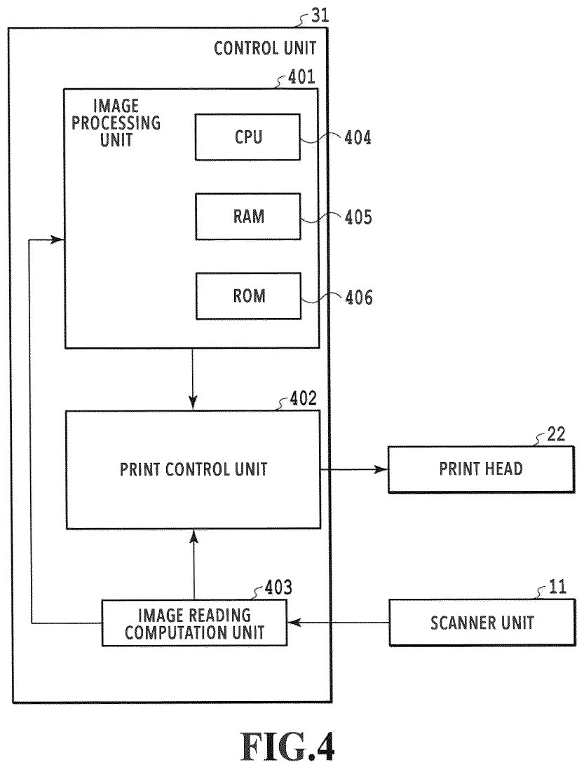

FIG. 4 illustrates a block diagram related to the image processing unit 401, the print control unit 402, and the image reading computation unit 403 in the control unit 31.

The image processing unit 401 performs γ correction, color processing, binarization (halftone process), an enlargement or reduction process, and so on on print data (multivalued image data) transferred from the host computer or the like through an interface.

The print control unit 402 controls the print heads 22 as illustrated in FIG. 9 based on the print data. Specifically, the print control unit 402 can be configured to load control parameters and print data from predetermined addresses in the RAM 405.

In response to the CPU 404 writing control parameters and print data to predetermined addresses in the RAM 405, the print control unit 402 starts an image forming process, in which the print heads 22 perform ink ejection operations.

The print control unit 402 controls the print heads 22 as illustrated in FIG. 9 based on the print data. Specifically, the print control unit 402 can be configured to load control parameters and print data from predetermined addresses in the RAM 405.

In response to the CPU 404 writing control parameters and print data to predetermined addresses in the RAM 405, the print control unit 402 starts an image forming process, in which the print heads 22 perform ink ejection operations, and the sheet S on which an image is printed is output.

The image reading computation unit 403 obtains a read image read by the scanner unit 11, reads a test image and a maintenance pattern, calculates registration misalignment information and color information, and sends the calculation results to the image processing unit 401 and the print control unit 402. The image processing unit 401 and the print control unit 402 adjusts the printing position of the printing unit 7. The method in which the printing position is adjusted based on position information of the maintenance pattern read by the scanner unit 11 will be referred to herein as “automatic registration adjustment.” The adjustment of the printing position involves adjusting the positions at which the first printing unit 7a and the second printing unit 7b start printing and, in addition, adjusting the printing position of the first printing unit 7a to change the size of the image to be printed by the first printing unit 7a according to the expansion or contraction of the print medium resulting from drying. Note that, instead of the first printing unit 7a, the second printing unit 7b may perform the adjustment of the printing position, or each of them may perform part of the adjustment. In an example method for the adjustment of the printing position according to the expansion or contraction of the print medium, the image reading computation unit 403 calculates the amount of expansion or contraction of the maintenance pattern printed by the first printing unit 7a, and the image processing unit 401 performs an enlargement or reduction process on the print data for the first printing unit 7a. In another method, the image reading computation unit 403 calculates the amount of expansion or contraction of the maintenance pattern printed by the first printing unit 7a, and the print control unit 402 adjusts the ejection timing for the first printing unit 7a. The amount of expansion or contraction of the maintenance pattern printed by the first printing unit 7a can be calculated from the amount of registration misalignment between the maintenance pattern printed by the first printing unit 7a and the maintenance pattern printed by the second printing unit 7b. Details of the automatic registration adjustment will be described later.

The maintenance unit 15 is a unit including a mechanism that recovers the ejection performance of the print heads 22. Examples of the mechanism that recovers the ejection performance include a cap mechanism that protects the ink ejection surfaces of the print heads 22, a wiper mechanism that wipes the ink ejection surfaces, a suction mechanism that sucks the inks inside the print heads 22 from the ink ejection surfaces by a negative pressure, and so on. Also, the maintenance unit 15 is provided with a driving mechanism and a rail not illustrated and is horizontally reciprocally movable along the rail. The maintenance unit 15 moves to directly under the print heads 22 only in a case of performing maintenance, and moves to positions away from directly under the print heads 22 at other times. In the present embodiment, first maintenance unit 15a and a second maintenance unit 15b corresponding to the first printing unit 7a and the second printing unit 7b are provided, respectively.

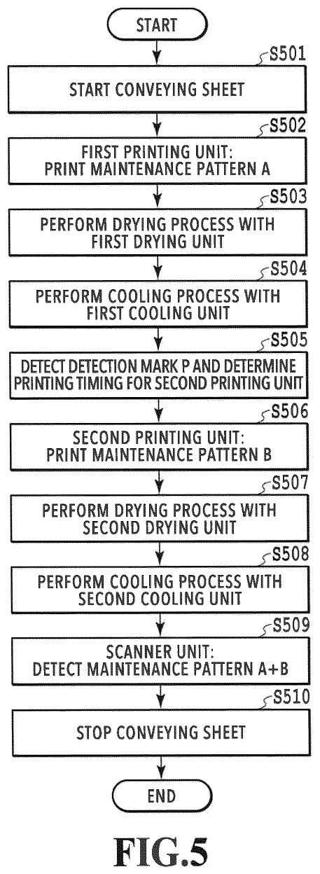

FIG. 5 illustrates a flowchart describing the operation of the printing apparatus according to the present embodiment from printing the maintenance pattern on a print medium (sheet S) to reading the printed maintenance pattern.

The maintenance pattern is a pattern to be used to calculate registration adjustment values (hereinafter referred to also as “adjustment values”) based on the result of measuring it. This adjustment values are stored in the RAM 405 or the like, for example. Also, for example, the ejection timing for the ink to be ejected from each nozzle is adjusted based on the adjustment value stored in the RAM 405 or the like to correct the landing positions (printing positions) of dots to be formed on the print medium.

In S501, the control unit 31 starts conveying the sheet S using the conveyance mechanism.

In S502, with the first printing unit 7a, the control unit 31 starts printing a later-described maintenance pattern A formed of the reaction liquid and the white ink on the sheet S in response to the sheet S reaching a given speed. The maintenance pattern A includes a detection mark P to be detected by the second conveyance detection unit 6b and the scanner unit 11.

In S503, the control unit 31 performs a drying process with the first drying unit 40a on the portions of the sheet S on which the maintenance pattern A has been printed.

In S504, the control unit 31 performs a cooling process with the first cooling unit 50a on the portions of the sheet S on which the maintenance pattern A has been printed and the drying process has been performed.

The maintenance pattern A is heated by the drying by the first drying unit 40a in S503 and cooled by the first cooling unit 50a in S504 and then reaches the upstream side of the second printing unit 7b.

By being subjected to the heating and cooling process as described above, the sheet S gets subtly deformed in both the same direction as the conveyance direction and a direction perpendicular to the conveyance direction, and the maintenance pattern A also gets deformed by the deformation of the sheet S.

In S505, the control unit 31 determines the image printing timing for the second printing unit 7b in a case where the maintenance pattern A reaches the upstream side of the second printing unit 7b and the second conveyance detection unit 6b detects the detection mark P.

In S506, with the second printing unit 7b, the control unit 31 starts printing a maintenance pattern B formed of the reaction liquid and the color (C, M, Y, K, and spot color) inks on the maintenance pattern A on the sheet S with the printing timing determined in S505. As a result, the maintenance pattern A and the maintenance pattern B are formed one on top of the other on the sheet S. Here, the portions of the sheet S on which the maintenance pattern A has been printed are subtly expanded or contracted as a result of being subjected to the heating and cooling process, and the maintenance pattern A is also expanded or contracted due to the expansion or contraction of the sheet S. For this reason, color shifts have occurred between the maintenance pattern A and the maintenance pattern B.

In S507, the control unit 31 performs a drying process with the second drying unit 40b on the portions of the sheet S on which the maintenance patterns A and B have been printed.

In S508, the control unit 31 performs a cooling process with the second cooling unit 50b on the portions of the sheet Son which the maintenance patterns A and B have been printed and the drying process has been performed.

In S509, the control unit 31 detects the maintenance patterns A and B with the scanner unit 11 in response to detection of the detection mark P by the scanner unit 11 as a trigger.

In S510, the control unit 31 stops conveying the sheet S in a case where the maintenance patterns A and Bare conveyed to the winding unit 14.

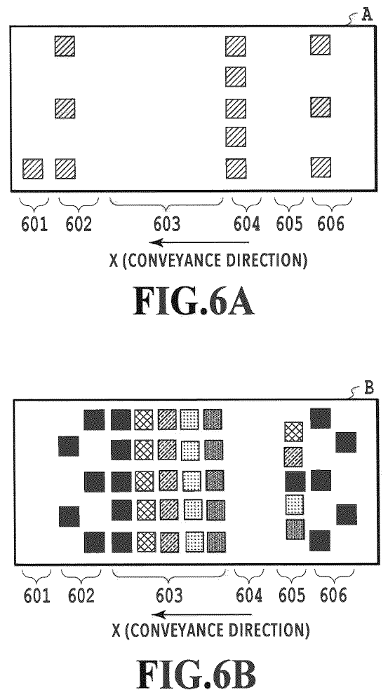

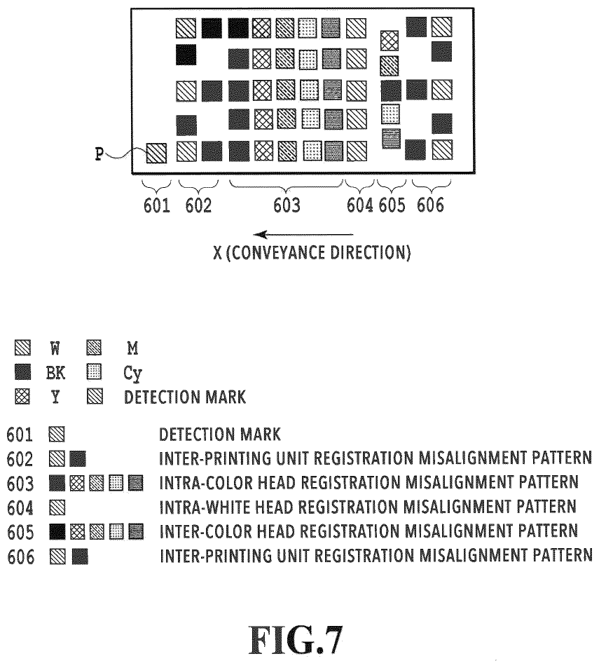

FIGS. 6A, 6B, and 7 illustrate the maintenance pattern used in the present embodiment. As illustrated in FIGS. 6A and 6B, the maintenance pattern is the maintenance pattern A (FIG. 6A), which is formed of a reaction liquid and the white ink, and the maintenance pattern B (FIG. 6B), which is formed of a reaction liquid and the color inks, printed one on top of the other (FIG. 7). As illustrated in FIGS. 6A, 6B, and 7, the maintenance pattern is divided into areas 601 to 606 in this order from the upstream side in the conveyance direction.

In the area 601, the detection mark P is printed with the white ink. The first printing unit 7a and the second printing unit 7b perform printing on the areas 602 to 606 in response to detection of the detection mark P by the second conveyance detection unit 6b as a trigger.

In the area 602, a registration misalignment pattern between the printing units, the pattern including multiple combinations of white (W) and black (Bk) patterns, is printed for detecting a relative misalignment in printing position between the first printing unit 7a and the second printing unit 7b. From the area 602, a registration misalignment between the printing units as a misalignment between the printing positions of the first printing unit 7a and the second printing unit 7b that are based on detection of the detection mark P by the second conveyance detection unit 6b as a trigger, can be read. In the reading of this registration misalignment between the printing units, the registration misalignment within the white (W) print head 22 of the first printing unit 7a and the registration misalignment within the color (Bk) print head 22 of the second printing unit 7b read from other areas are reflected. The registration misalignment within a print head is a registration misalignment originating from variations in the positional relationship between the print chips or nozzle arrays of the print head 22. Also, from the area 602, a registration misalignment between the printing units in the width direction can be read which originates from the expansion or contraction of the sheet S in the width direction by the heating and cooling by the first drying unit 40a and the first cooling unit 50a.

In the area 603, a registration misalignment pattern for the color print head, the pattern including multiple combinations of Bk, Y, M, Cy, and spot color patterns, is printed. From the area 603, a misalignment in the printing position of each color ink print head 22 of the second printing unit 7b can be read which originates from variations in the positional relationship between the print chips or nozzle arrays in the print head.

In the area 604, a registration misalignment pattern for the white print head, the pattern including multiple combinations of W patterns, is printed. From the area 604, a misalignment in the printing position of the W ink print head 22 of the first printing unit 7a can be read which originates from variations in the positional relationship between the print chips or nozzle arrays in the print head.

In the area 605, a registration misalignment pattern for the color print head, the pattern including multiple combinations of Bk, Y, M, Cy, and spot color patterns, is printed. From the area 605, misalignments in printing position between the color print heads 22 (Bk, Y, M, Cy, and spot colors) of the second printing unit 7b can be read.

In the area 606, a registration misalignment pattern for the printing unit, the pattern including multiple combinations of white (W) and color (Bk) patterns, is printed. The registration misalignment pattern in the area 606 is a pattern obtained by reversing the registration misalignment pattern between the printing units in the area 602 in the sheet conveyance direction (in the left-right direction in FIGS. 6A, 6b, and 7). Thus, a registration misalignment similar that in the area 602 can be read from the area 606. In addition, from the area 606, a registration misalignment between printing units is read which originates from the expansion or contraction of the sheet S in the conveyance direction and the width direction due to the heating and cooling by the first drying unit 40a and the first cooling unit 50a. The registration misalignment between the printing units by the expansion or contraction of the sheet S in the conveyance direction is read from the area 606 because the amount of expansion or contraction of the sheet S in the conveyance direction increases the farther it is from the detection mark P. Hence, the registration misalignment between the printing units by the expansion or contraction of the sheet S in the conveyance direction can be read more easily and accurately from the area 606 than from the area 602.

Also, in the printing of the maintenance pattern A onto the sheet S, a pattern not illustrated is printed outside the printing area for the maintenance patterns A and Bin the average amount of ejection of the white ink for actual printing in such a way that the amount of ejection is uniform. This pattern is intended to reproduce the expansion or contraction of the white ink by the latent heat involved in the heating and cooling of the sheet S and the ink by the first drying unit 40a and the first cooling unit 50a in actual printing that is not test printing.

This can reduce the difference in condition between the test printing and the actual printing and thus decrease the errors between the amounts of the registration misalignments calculated from the maintenance patterns A and B and the amounts of registration misalignments in the actual printing. Incidentally, while an example with only the white ink has been described above, both the white ink and the color inks may be used. By doing so, the test printing will be closer to the actual printing.

Here, while the maintenance pattern in the present embodiment 1s illustrated in FIGS. 6A, 6B, and 7 and has been as above, the order of the areas 601 to 606 is not limited to the one thus illustrated and described, and the order may be changed or some of the areas may be omitted. Also, other maintenance patterns may be combined, or the maintenance pattern may be divided and the divided patterns may be disposed with an interval therebetween. For example, only the correction patterns in the areas 601, 602, and 606 may be used in a case where the maintenance pattern is dedicated to correcting the registration misalignment (color shift) between the printing units originating from the expansion or contraction of the sheet S by the heating and cooling. In this case, the interval between the area 602 and the area 606 may be set as appropriate according to the correction accuracy.

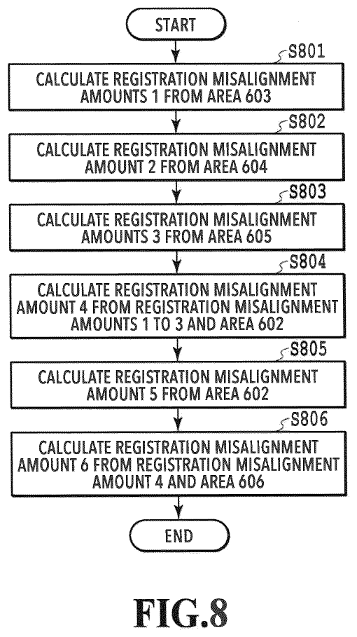

FIG. 8 illustrates a flowchart describing a method of calculating the amounts of various registration misalignments from the maintenance pattern in the present embodiment. Note that, while each registration misalignment amount may be calculated as the difference between predetermined positions on the corresponding patterns, such as their centers or predetermined ends, the method of calculating each registration misalignment amount is not limited to this, and any of other existing calculation methods may be used.

In S801, registration misalignment amounts 1 within respective print heads included in the second printing unit 7b are calculated based on the intra-color print head registration misalignment pattern detected from the area 603.

Specifically, the registration misalignment amounts 1 includes an amount of registration misalignment for each of Bk, Y, M, Cy, and each of the spot colors.

In S802, a registration misalignment amount 2 within the white (W) print head 22 of the first printing unit 7a is calculated based on the intra-white print head registration misalignment pattern detected from the area 604.

In S803, a registration misalignment amounts 3 between the print heads 22 for different colors included in the second printing unit 7b are calculated based on the inter-color print head registration misalignment pattern detected from the area 605. Note that the registration misalignment amounts 3 may be based on, for example, Bk, and the amounts of the registration misalignments between the Bk print head 22 and the print heads 22 for the other colors may be calculated.

In S804, a registration misalignment amount 4 between the first printing unit 7a and the second printing unit 7b is calculated based on the registration misalignment pattern between the printing units detected from the area 602 and the registration misalignment amounts 1 and 2 calculated in S801 and S802. More specifically, this registration misalignment amount 4 is the amount of registration misalignment between the white (W) print head 22 of the first printing unit 7a and the Bk print head 22 of the second printing unit 7b.

In S805, a registration misalignment amount 5 resulting from the expansion or contraction of the sheet S in the width direction due to heating and cooling is calculated based on the registration misalignment pattern between the printing heads detected from the area 602 and the registration misalignment amounts 1 and 2 calculated in S801 and S802. The heating and cooling in the above are the ones performed by the first drying unit 40a and the first cooling unit 50a.

In S806, a registration misalignment amount 6 between the printing heads resulting from the expansion or contraction of the sheet Sin the conveyance direction due to the heating and cooling is calculated based on the registration misalignment pattern between the printing heads detected from the area 606 and the registration misalignment amount 4 calculated in S804. In the maintenance pattern in the present embodiment, the areas 602 to 605 are disposed between the area 601 and the area 606 to leave a long distance for calculating the amount of expansion or contraction of the sheet S. Accordingly, the amount of expansion or contraction of the sheet S in the conveyance direction to be read is large, allowing for accurate calculation of the scaling ratio.

As described above, the maintenance pattern in the present embodiment makes it possible to calculate the amounts of multiple types registration misalignments with a single maintenance pattern.

Next, a description will be given of an automatic registration adjustment method according to the present disclosure in which the registration misalignment amounts 1 to 6 calculated by the image reading computation unit 403 are applied to actual printing via the image processing unit 401 and the print control unit 402.

The image reading computation unit 403 outputs to the print control unit 402 the calculated values of the registration misalignment amounts 1 within the print heads of the second printing unit. Based on the input registration misalignment amounts 1, the print control unit 402 corrects the ejection timings for the nozzles in the print heads 22 of the second printing unit 7b.

The image reading computation unit 403 outputs to the print control unit 402 the calculated value of the registration misalignment amount 2 within the print head of the first printing unit 7a. Based on the input registration misalignment amount 2, the print control unit 402 corrects the ejection timings for the nozzles in the white (W) print head 22 of the first printing unit 7a.

The image reading computation unit 403 outputs to the print control unit 402 the calculated values of the registration misalignment amounts 3 between the color print heads of the second printing unit 7b. Based on the input registration misalignment amounts 3, the print control unit 402 corrects the ejection timing between the print heads for the different colors of the second printing unit 7b.

The image reading computation unit 403 outputs to the print control unit 402 the registration misalignment amount 4 between the first printing unit 7a and the second printing unit 7b. Based on the input registration misalignment amount 4, the print control unit 402 corrects the ejection timings for the print heads 22 in the second printing unit 7b which are based on detection of the detection mark P by the conveyance detection unit 6 as a trigger.

The image reading computation unit 403 outputs to the image processing unit 401 the calculated value of the registration misalignment amount 5 between the printing heads. The misalignment results from the expansion or contraction of the sheet S in the width direction, caused by heating and cooling by the first drying unit 40a and the first cooling unit 50a. The image processing unit 401 calculates the ratio of expansion or contraction in the width direction based on the input registration misalignment amount 5 and the distance between Bk patterns disposed next to each other in the width direction in the area 602, and performs a width-direction scaling process on the image data for the first printing unit 7a based on the calculated scaling ratio. Incidentally, the image reading computation unit 403 may calculate this scaling ratio and output it to the image processing unit 401. In that case, the image processing unit 401 does not calculate the scaling ratio but performs an scaling process on the image data based on the input scaling ratio.

The image reading computation unit 403 outputs to the image processing unit 401 the calculated value of the registration misalignment amount 6 between the printing heads. The misalignment results from the expansion or contraction of the sheet S in the conveyance direction, caused by heating and cooling by the first drying unit 40a and the first cooling unit 50a. The image processing unit 401 calculates the ratio of expansion or contraction in the conveyance direction based on the input registration misalignment amount 6 and the distance from the detection mark P to the area 606, and performs a conveyance-direction scaling process on the image data for the first printing unit 7a based on the calculated scaling ratio.

Incidentally, instead of performing the conveyance-direction scaling process on the image data, the ejection frequency of the print head 22 of the first printing unit 7a may be adjusted based on the calculated scaling ratio.

Also, instead of performing the above process based on the scaling ratio on the image data for the first printing unit 7a or the print head 22 of the first printing unit 7a, the process may be performed on the image data for the second printing unit 7b or the print heads 22 of the second printing unit 7b. In this case, the process of expanding or contracting the image data for the second printing unit 7b or the adjustment of the ejection frequency of the print heads 22 of the second printing unit 7b may be performed based on the calculated scaling ratio to adjust to the image printed by the first printing unit 7a and distorted by the expansion or contraction of the sheet S.

Also, the image processing unit 401 may hold scaling information including an scaling ratio for each type of sheet S, and perform registration adjustment, such as the image data scaling process and ejection frequency adjustment described above, based on the scaling ratio corresponding to a type of sheet S received from the user, for example. In this case, the step of calculating the scaling ratio of the print medium from the maintenance pattern can be omitted.

Note that the automatic registration adjustment which applies the above-described registration misalignment amounts 1 to 6 to printing may be performed at the time of performing normal printing in response to receiving a normal print job after printing the maintenance pattern and temporarily stopping the sheet conveyance. Alternatively, the configuration may be such that the automatic registration adjustment is performed at the time of performing normal printing continuously after printing the maintenance pattern without stopping the sheet conveyance.

With the configuration described above, a printing apparatus including separate printing units for a white ink and color inks and including a drying unit between the white printing unit and the color printing unit can print high-quality images with reduced color shifts.

In the present embodiment, a configuration using inkjet print heads as the first printing unit 7a and the second printing unit 7b has been described, but a printing apparatus using a different printing method may be employed. Also, in Embodiment 1, a configuration in which the first printing unit 7a uses a white ink and the second printing unit 7b uses color inks is employed, but the ink configuration is not limited to this, and a different ink configuration may be employed. That is, the present embodiment enables a printing apparatus to print high-quality images with reduced color shifts as long as the printing apparatus is provided with multiple printing units and includes a drying unit between those printing units.

Also, the present embodiment has been described as the printing apparatus 1 in the above, but does not need to include all of the features of the printing apparatus 1 and only needs to be a configuration that causes a printing apparatus to execute at least the processes of the image processing unit 401, the print control unit 402, and the image reading computation unit 403.

### Embodiment 2

Embodiment 1 described above is characterized by focusing on a misalignment in printing position in the conveyance direction and using a detection mark to allow for registration adjustment that aligns the positions of dots by a first printing process and those by a second printing process with each other. Note that the printing positions may be misaligned not only in the conveyance direction but also in the direction perpendicular to the conveyance direction, i.e., the width direction of the print medium. As will be described later, depending on the settings at the time of feeding the sheet, the amount of misalignment in the width direction of the print medium may make it impossible to perform registration adjustment. Embodiment 2 is characterized by taking the positional misalignment in the width direction into account to reduce the possibility of becoming unable to execute registration adjustment for a first printing unit and a second printing unit. More specifically, Embodiment 2 is a technique related to the printing positions of the detection mark and the maintenance pattern described in Embodiment 1.

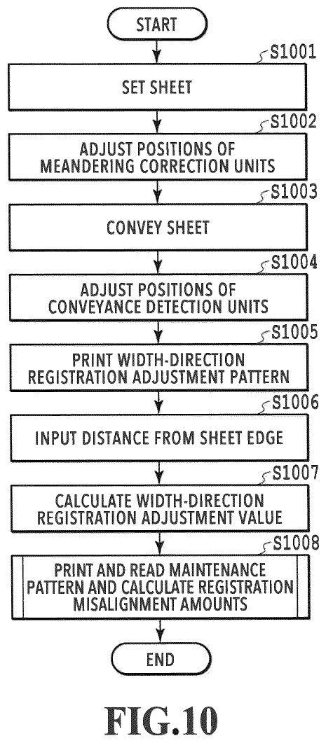

FIG. 10 illustrates a flowchart for describing processing during sheet feed in Embodiment 2. In a case of conveying a sheet which is a print medium as described above using FIG. 1, the printing apparatus 1 performs meandering correction with the meandering correction units 5a and 5b to prevent meandering of the sheet in the width direction.

In S1001, a sheet which is a print medium to be used in printing is set. At this time, the width of the set sheet is input into the printing apparatus 1. The printing apparatus 1 determines the print range of the image data in the width direction according to the input value of the sheet width. For example, consider a case where printing is to be performed on a narrow sheet but image data having a larger width than the sheet width has been input. In this case, the control unit 31 adjusts the size of the image to be printed according to the sheet width. Doing so can prevent contamination of the conveyance path in the printing apparatus 1 with the inks as a result of performing printing on the outside of the sheet. While the width of the fed sheet can be detected using a sensor capable of detecting the sheet width in the printing apparatus 1, the present embodiment employs a configuration in which the user inputs the width through the operation panel of the printing apparatus 1 or an application.

In S1002, the positions of the meandering correction units 5a and 5b are adjusted according to the width of the fed sheet. The meandering correction units 5a and 5b have a configuration to designate the positions of the edges of the sheet in order to specify its position in the width direction. The user adjusts dials provided to the meandering correction units 5a and 5b according to the width of the fed sheet. The meandering correction units 5a and 5b perform control to stably convey the edges of the sheet at the set edge positions and thereby keep the sheet from moving in the width direction. That is, as a result of the user's dial adjustment, the positional relationship between the sheet edges and the print heads at each of the first printing unit and the second printing unit is determined. The user needs to change the positions of the meandering correction units 5a and 5b each time the width of the sheet to be used changes.

In S1003, the sheet is conveyed.

In S1004, the positions of the conveyance detection units 6a and 6b in the width direction are adjusted. The conveyance detection units 6a and 6b need to be adjusted to positions where they can detect the detection mark printed on the sheet. The detection mark is desirably positioned at an edge of the sheet so as to avoid overlap with images other than the detection mark during printing. In the present embodiment too, the detection mark is printed at the edge of the sheet in the −y direction. The positions of the conveyance detection units 6a and 6b are adjusted in a state where the sheet is conveyed. Thus, the positions can be adjusted based on the positions of the edges of the sheet kept from moving in the width direction by the meandering correction units 5a and 5b. The user adjusts the positions of the conveyance detection units 6a and 6b to the edge of the sheet in the −y direction so that the detection mark to be detected will pass directly under the conveyance detection units 6a and 6b.

Incidentally, the positions of the conveyance detection units 6a and 6b may be adjusted using a mechanism that reads the positions of the edges of the sheet with a sensor or the like, and automatically moves the conveyance detection units 6a and 6b to appropriate positions based on the read positions of the edges of the sheet. Adjustment by the user can reduce the apparatus cost, as a matter of course. In the present embodiment too, a configuration involving manually adjusting the positions is employed. The user measures the distance to determine the value, and accuracy on the order of about 0.5 mm can be expected, but it is impossible to achieve accuracy on the order of several tens of micrometers required for the registration adjustment.

Also, the user adjusts the positions of the conveyance detection units 6a and 6b, which can lead to a problem that their positions are shifted, as with the meandering correction units 5a and 5b. Since the conveyance detection units 6a and 6b only needs to be able to detect the detection mark, increasing the size of the detection mark can increase the tolerance to positional misalignments. In the present embodiment, the size of the detection mark in the width direction is set to 3 mm. In this way, the detection mark can be detected as long as the positional misalignment from the position of the edge of the sheet is within the range of ±1 mm. Such a condition should be sufficient to perform user adjustment. However, in a case where the position of the edge of the sheet and the position of the detection mark are not aligned, the detection mark cannot be detected, as a matter of course. Thus, a width-direction registration adjustment value based on the edge registration value to be described later is applied to the printing position of the image data to adjust the distance between the position of the edge of the sheet and the printing position of the detection mark.

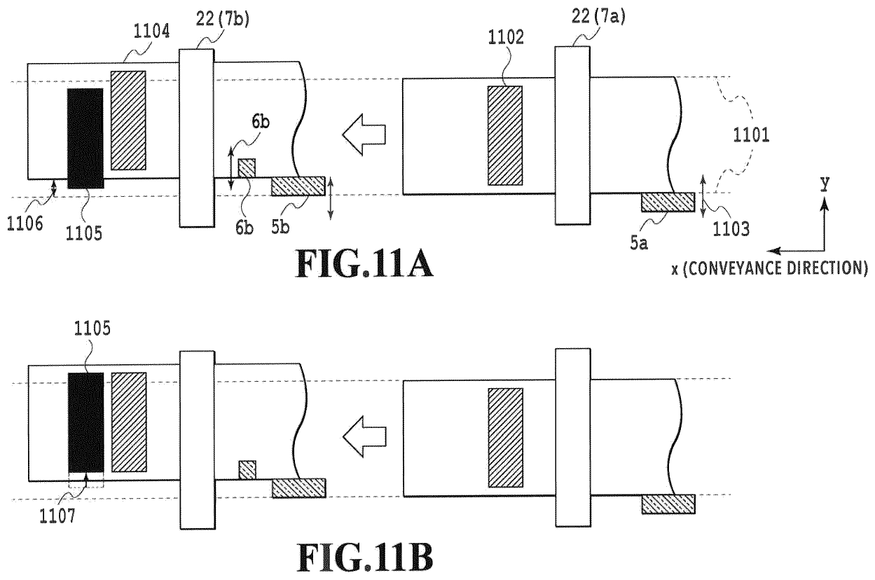

FIGS. 11A and 11B illustrate diagrams for describing details of S1001 to S1004. In FIGS. 11A and 11B, only the portions of the meandering correction units 5a and 5b that specifies the position of the edge of the sheet are illustrated, and the user adjusts the positions of the meandering correction units 5a and 5b in the direction of an arrow 1103 according to the sheet width. Dashed lines 1101 indicate ideal conveyance positions corresponding to the width of the fed sheet, and the sheet width is a value input by the user, as mentioned earlier. At the first printing unit 7a, the position of the meandering correction unit 5a has been appropriately adjusted to the position indicated by one dashed line 1101. A W image 1102 represents a W image printed by the print head 22, and is printed with a certain amount of margin set from either edge of the sheet.

At the second printing unit 7b, the position of the meandering correction unit Sb has been adjusted to a position shifted from the dashed line 1101. Accordingly, the sheet is shifted from the ideal position by the distance indicated by an arrow 1106, so that a Bk image 1105 printed by the Bk print head 22 sticks out from the edge of the sheet (FIG. 11A). To prevent the Bk image 1105 from sticking out from the sheet, it is necessary to check the distance from the dashed line 1101 to the edge of the sheet at the second printing unit 7b (hereinafter “edge registration value”) and shift the image printing position.

In FIG. 11B, on the other hand, a width-direction registration adjustment value calculated by a method to be described later is applied to the printing position of the Bk image 1105 to shift the original printing position of the Bk image 1105 by the edge registration value in the direction indicated by an arrow 1107. As a result, in FIG. 11B, the Bk image 1105 is printed at an appropriate position in the width direction like the W image 1102, for which the set position of the meandering correction unit Sa is not shifted

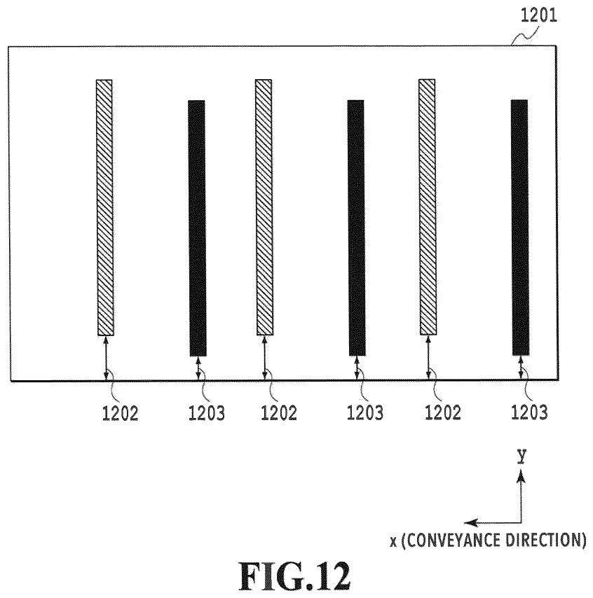

In S1005, a width-direction registration adjustment pattern is printed in order to obtain the width-direction registration adjustment value indicated by the arrow 1107. FIG. 12 illustrates an example of a width-direction registration adjustment pattern 1201 printed in S1005 in order to obtain the width-direction registration adjustment value. W straight patterns 1202 and Bk straight patterns 1203 for measuring the misalignment of the printing position in the width direction from the edge of the sheet are printed. A predetermined amount of margin is specified which prevents ends of the straight patterns 1202 and 1203 from sticking out from the sheet even in a case where the position of the meandering correction unit Sb is shifted to the greatest extent possible. In the present embodiment, that amount of margin is 5 mm. In the sequence for printing the width direction registration adjustment pattern, the detection mark is not used to determine the timing for the second printing unit 7b to start the printing. Instead, the ejection timing for the second printing unit 7b is determined based on the internal time of the printing apparatus 1. In printing the width-direction registration adjustment pattern, it is preferable that the W straight patterns 1202 and the Bk straight patterns 1203 not overlap each other since the distance to the edge of the sheet is to be measured from each of the W straight patterns 1202 and the Bk straight patterns 1203. Hence, the detection mark is not used in the printing of the width-direction registration adjustment pattern, and letting the W straight patterns 1202 and the Bk straight patterns 1203 shift in the conveyance direction is not problematic. Incidentally, the edge registration value is determined by the position of the meandering correction unit Sb. Thus, edge registration values for the other colors than Bk for the second printing unit 7b do not need to be measured and may be assumed to have the same value as the edge registration value for Bk.

In S1006, the user measures the distance from the edge of the sheet to each of the straight patterns 1202 and 1203 of the printed width-direction registration adjustment pattern and inputs the distance into the printing apparatus 1.

In S1007, a width-direction registration adjustment value is calculated based on the input distance from the edge of the sheet to the width-direction registration adjustment pattern. The edge registration value can be derived as the difference between the distance from the edge of the sheet to the printed width-direction registration adjustment pattern and the distance from the edge of the sheet to the ideal position of the width-direction registration adjustment pattern. Incidentally, in FIGS. 11A and 11B, the edges of the sheet are aligned with the ideal positions 1101 at the first printing unit 7a for brevity of description. In reality, however, the edges of the sheet are shifted from the ideal positions 1101 at the first printing unit 7a as well. For this reason, in S1007, a width-direction registration adjustment value is calculated also for the W straight patterns 1202. In the following, a method of calculating the width-direction registration adjustment value will be describing using specific numbers. Assume that the distance measured in S1006 from the edge of the sheet to each straight pattern 1202 printed with the Wink was 7 mm. This means that the meandering correction unit 5a has been shifted by 2 mm in the −y direction since that distance should be 5 mm if the meandering correction unit 5a has been adjusted to its ideal position. Thus, the edge registration value for the first printing unit 7a is 2 mm, and the width-direction registration adjustment value is −2 mm. On the other hand, in a case where the distance measured in S1006 from the edge of the sheet to each straight pattern 1203 printed with the Bk ink was 4 mm, it means that the meandering correction unit 5b has been shifted by 1 mm in the +y direction. Thus, the edge registration value for the second printing unit 7b is 1 mm, and the width-direction registration adjustment value is 1 mm.

Incidentally, in the present embodiment, the print heads 22 are longer than the sheet width. Thus, even in a case where the printing position of an image is moved in the width direction, the entirety of the input image data can be printed.

In the above, a method of calculating a misalignment in the printing position in the sheet width direction between the first printing unit 7a and the second printing unit 7b which originates from positional adjustment of the meandering correction units 5a and 5b has been described using FIGS. 10, 11A, and 11B. By applying the width direction registration adjustment value calculated in S1007 to the printing position of image data, it is possible to prevent a misalignment in the printing position in the width direction even in a case where the positions of the meandering correction units 5a and 5b are shifted from the ideal conveyance position 1101.

The present embodiment is intended to correct the registration misalignment in the sheet width direction originating from the positional adjustment of the meandering correction units 5a and 5b by the user, but heat contraction by a heat drying mechanism as described in the foregoing embodiment can also cause a registration misalignment in the width direction. In the present embodiment, the width-direction registration adjustment value is calculated with a pattern after the heat contraction. This makes it possible to correct the edge position.

S1008 involves printing the maintenance pattern described in Embodiment 1 using FIG. 5 and calculating the registration misalignment amounts described using FIG. 8. The printing position of the detection mark in the maintenance pattern is determined by applying the width-direction registration adjustment value calculated in S1007. In this way, the detection mark can be printed within the detection range of the conveyance detection unit 6b even in a case where the position of the sheet is shifted in the width direction.

By adjusting the printing positions of the first printing unit 7a and the second printing unit 7b as described above using FIGS. 10 to 12, the printing apparatus 1 can detect the detection mark printed at the edge of the sheet. As a result, by printing the maintenance pattern for obtaining registration values between the first printing unit 7a and the second printing unit 7b and between their chips and reading it with the scanner unit 11, it is possible to implement high-definition printing position adjustment on the order of several tens of micrometers.

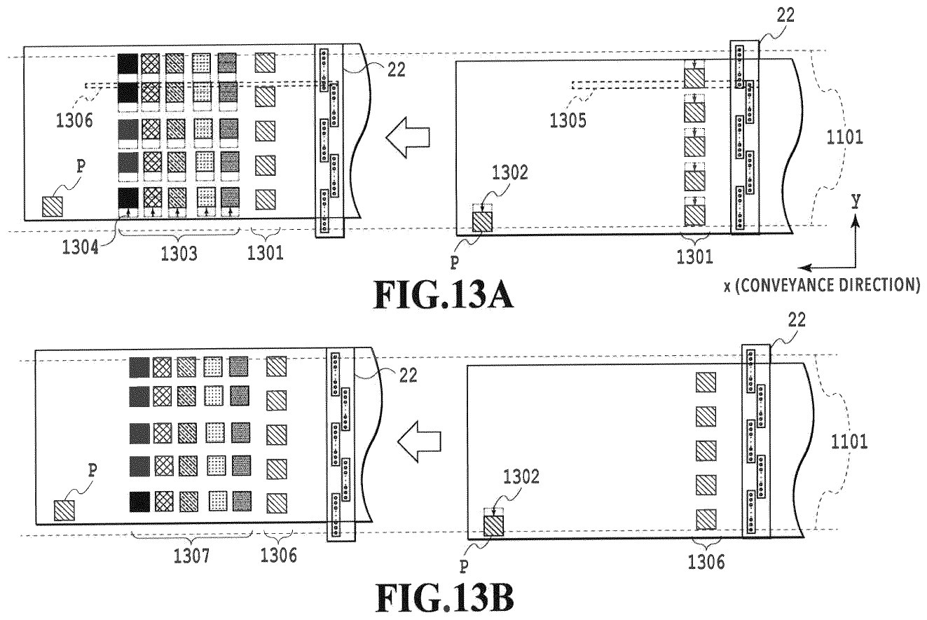

Note that applying the width-direction registration adjustment value to the maintenance pattern may make it impossible to perform automatic registration adjustment between chips in particular. A problem that may occur as a result of applying the width-direction registration adjustment value to the entire maintenance pattern including the detection mark and a countermeasure against it will now be described using FIGS. 13A and 13B.

FIG. 13A illustrates a case where a width-direction registration adjustment value is calculated and then applied to the detection mark P and the maintenance pattern. The sequence for calculating the width-direction registration adjustment value described earlier has been performed, and the width-direction registration adjustment value for the first printing unit 7a is 2 mm in the −y direction. A width-direction registration adjustment value of +2 mm means that the sheet is shifted by 2 mm in the −y direction from the ideal position 1101. Thus, the printing positions of the detection mark P and a maintenance pattern 1301 are shifted in the −y direction by 2 mm as indicated by an arrow 1302. Next, the sheet is conveyed to the second printing unit 7b. Here, since the edge registration value has been applied, the detection mark P is detected by conveyance detection unit, so that a Bk, C, M, and Y maintenance pattern 1303 is printed. The maintenance pattern 1303 is shifted in the +y direction by 1 mm as indicated by an arrow 1304 since the edge registration value for the second printing unit 7b is −1 mm.

The maintenance patterns 1301 and 1303 are designed such that one pattern can be printed and detected per chip in the print head 22 and thus inter-chip registration values can be calculated. Here, as indicated by the areas surrounded by dashed frames 1305 and 1306 illustrated in FIG. 13A, a pattern that was supposed to be printed by a single chip was printed by multiple chips due to the application of the width direction registration adjustment value also to the printing positions of the maintenance patterns 1301 and 1303.

As described above, applying the width-direction registration adjustment value to the maintenance pattern may not be suitable for obtaining the registration value between head chips. Still, it is necessary to apply the width-direction registration adjustment value in order to detect the detection mark P with the conveyance detection unit. Thus, in the present embodiment, the detection mark P is printed with the width direction registration adjustment value applied, but the maintenance pattern is printed without the width-direction registration adjustment value applied to maintain its original printing position. In this way, even in a case where the adjusted positions of the meandering correction units 5a and 5b are not aligned, it is possible to detect the detection mark P and appropriately adjust the inter-chip registration.

Note that the method of calculating the edge registration value in the present embodiment is not limited to the method in which the user measures the edge registration value and inputs it into the printing apparatus 1, as described in S1006. A printing apparatus that automatically detects the edge registration value with a sensor and adjusts the printing position of an image according to that edge registration value can achieve similar effects to those by the present embodiment.

### Embodiment 3

In the foregoing embodiments, problems related to the inter-color registration and the inter-chip registration have been described. In Embodiment 3, a problem related to the inter-array registration within a chip will be described.

While the print head illustrated in FIG. 9 is a print head having a single nozzle array per chip, it is preferable that multiple nozzle arrays be provided in each chip. By increasing the number of nozzle arrays, even when printing is performed in a single scan, image disturbance can be suppressed in a manner similar to multipass printing, even if landing misalignment occurs, thereby improving so-called robustness.

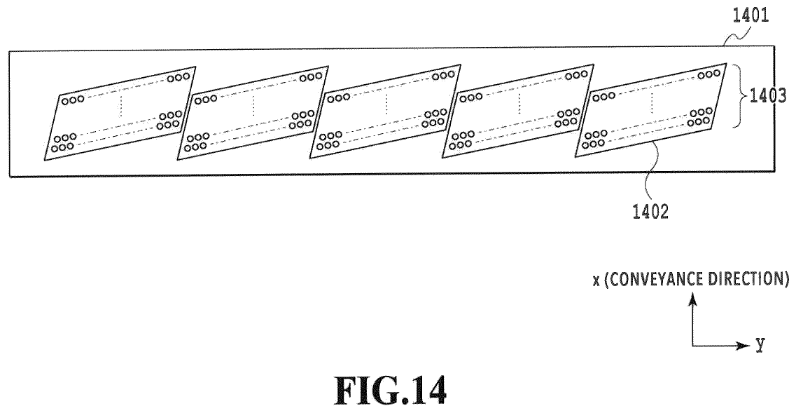

FIG. 14 illustrates an example configuration of a print head 1401 having multiple nozzle arrays in its chips. The print head 1401 is formed of multiple parallelogram head chips (head substrates) 1402 coupled in the y direction. In each head chip 1402, 16 nozzle arrays are disposed, and the nozzles forming each nozzle array are each disposed at a different position in the x direction and the y direction at a pitch corresponding to a resolution of 600 dpi. While the nozzles in each nozzle array are arrayed at a pitch corresponding to a resolution of 600 dpi, the nozzles are disposed to have an offset corresponding to ¼ of the pitch in the nozzle array direction (y direction) between the arrays. Accordingly, by combining sets of four continuous nozzle arrays, e.g., nozzle arrays 0 to 3 and nozzle arrays 4 to 7, printing can be performed at a resolution of 2400 dpi in the y direction. By setting the ejection timing for each nozzle in such a way as to cancel the amount and direction of offset of the landing position of the ink droplet that results from the above offsets in the x direction and the y direction, the ink can land straight in the y direction.

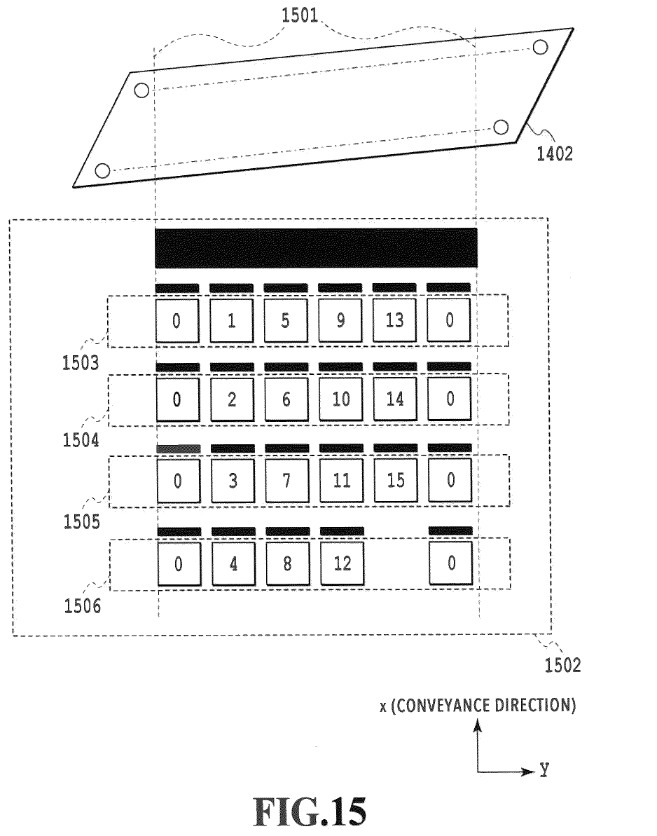

FIG. 15 describes a maintenance pattern 1502 for inter-array registration adjustment for adjusting the registration values of each nozzle array in the same head chip 1402 in the print head 1401 (hereinafter “inter-array registration”). To adjust the inter array registration misalignments within the head chip 1402, a pattern is provided for each nozzle array. The inter-array registration adjustment pattern 1502 for a single head chip 1402 is printed by using the nozzles in each nozzle array of the head chip 1402 within the range indicated by a dashed line 1501.

Pattern arrays 1503 to 1506 in the maintenance pattern 1502 each include patterns corresponding to predetermined nozzle arrays represented by blocks in which numbers are written. The patterns corresponding nozzle arrays are printed by using only the nozzle arrays corresponding to the written numbers. Using the arrangement of the nozzles that printed the pattern arrays 1503 to 1506, the positional misalignments are calculated from the relative positions between the patterns by the nozzle array O as reference patterns and the patterns by the rest of the nozzle arrays.

In the present embodiment, a width-direction registration adjustment value obtained by a similar method to those in the foregoing embodiments is applied to the printing position of the detection mark to enable the detection mark to be detected by the conveyance detection unit. Here, if the width-direction registration adjustment value is applied to the inter-array registration adjustment pattern, printing the patterns corresponding to the predetermined nozzle arrays may end up partly printing the patterns with other nozzle arrays that are adjacent to the nozzle arrays corresponding to the patterns.

Thus, in the inter-array registration adjustment too, applying the width-direction registration adjustment value to the maintenance pattern for inter-array registration adjustment may result in a failure to obtain appropriate registration adjustment values depending the configuration of the print head 1401. As in Embodiment 2, it is possible to omit applying the width-direction registration adjustment value to the maintenance pattern 1502. In this way, appropriate inter-array registration adjustment values can be obtained for the print head 1401 having a diagonal nozzle array layout as illustrated in FIG. 14.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications an equivalent structures and functions.

According to the present disclosure, it is possible to reduce color shifts by a printing apparatus that performs multiple separate printing processes.

This application claims the benefit of Japanese Patent Application No. 2024-177386, filed Oct. 9, 2024, which is hereby incorporated by reference herein in its entirety.

What is claimed is:

1. A printing apparatus comprising:
a first printing unit which prints a first image on a print medium;
a second printing unit which prints a second image on the print medium on which the first image has been printed by the first printing unit;
a control unit which controls a printing position of the first printing unit or a printing position of the second printing unit;
a detection unit which detects a detection mark printed by the first printing unit in order to determine printing timing for the second printing unit; and
an obtaining unit which obtains a first amount of misalignment and a second amount of misalignment, the first amount of misalignment corresponding to a misalignment in the printing position of the first printing unit on the print medium in a width direction of the print medium, the second amount of misalignment corresponding to a misalignment in the printing position of the second printing unit on the print medium in the width direction, wherein
in a case of printing a maintenance pattern for registration adjustment on the print medium as the first image and the second image, the control unit performs controls based on the first amount of misalignment and the second amount of misalignment obtained by the obtaining unit such that a printing position of the detection mark to be printed by the first printing unit will be within a detection range of the detection unit.

2. The printing apparatus according to claim 1, wherein in the case of printing the maintenance pattern for registration adjustment on the print medium as the first image and the second image, the control unit performs control based on the first amount of misalignment and the second amount of misalignment obtained by the obtaining unit such that a positional relationship between the maintenance pattern and the first and second printing units will be maintained without adjusting a printing position of the maintenance pattern to be printed by the first printing unit and the second printing unit.

3. The printing apparatus according to claim 1, further comprising a drying unit which is disposed between the first printing unit and the second printing unit and dries the print medium on which the first image has been printed.

4. The printing apparatus according to claim 1, wherein the control unit calculates the first amount of misalignment and the second amount of misalignment based on a distance between an edge of the print medium in the width direction and an image printed by the first printing unit and the second printing unit.

5. The printing apparatus according to claim 1, wherein the maintenance pattern includes a maintenance pattern for registration adjustment between head chips included in print heads of the first printing unit and the second printing unit.

6. The printing apparatus according to claim 1, wherein nozzle arrays in print heads of the first printing unit and the second printing unit are not parallel to the width direction of the print medium.

7. The printing apparatus according to claim 1, wherein the maintenance pattern includes a maintenance pattern for registration adjustment between nozzle arrays in print heads of the first printing unit and the second printing unit.

8. A control method comprising:
printing a first image on a print medium;
printing a second image on the print medium on which the first image has been printed by the printing the first image;
controlling a printing position of the first image or a printing position of the second image;
detecting a detection mark printed by the printing the first image in order to determine printing timing for the printing the second image; and
obtaining a first amount of misalignment and a second amount of misalignment, the first amount of misalignment corresponding to a misalignment in a printing position of the printing the first image on the print medium in a width direction of the print medium, the second amount of misalignment corresponding to misalignment in a printing position of the printing the second image on the print medium in the width direction, wherein
in a case of printing a maintenance pattern for registration adjustment on the print medium as the first image and the second image, the controlling includes performing control based on the first amount of misalignment and the second amount of misalignment obtained by the obtaining such that a printing position of the detection mark to be printed by the printing the first image will be within a detection range of the detecting.

9. A non-transitory computer readable storage medium storing a program for causing a computer to perform a printing method comprising:
printing a first image on a print medium;
printing a second image on the print medium on which the first image has been printed by the printing the first image;
controlling a printing position of the first image or a printing position of the second image;
detecting a detection mark printed by the printing the first image in order to determine printing timing for the printing the second image; and
obtaining a first amount of misalignment and a second amount of misalignment, the first amount of misalignment corresponding to a misalignment in a printing position of the printing the first image on the print medium in a width direction of the print medium, the second amount of misalignment corresponding to a misalignment in a printing position of the printing the second image on the print medium in the width direction, wherein
in a case of printing a maintenance pattern for registration adjustment on the print medium as the first image and the second image, the controlling includes performing control based on the first amount of misalignment and the second amount of misalignment obtained by the obtaining such that a printing position of the detection mark to be printed by the printing the first image will be within a detection range of the detecting.
